(19) United States
(12) Patent Application Publication
(10) Pub. No.: US 2020/0337934 A1
(43) Pub. Date: Oct. 29, 2020

(54) Power-assist Lower Limb Exoskeleton Robot with Adjustable Stiffness Joints

(71) Applicant: ANHUI POLYTECHNIC UNIVERSITY, Wuhu (CN)

(72) Inventors: Buyun WANG, Wuhu (CN); Dezhang XU, Wuhu (CN); Zhihong WANG, Wuhu (CN)

(73) Assignee: ANHUI POLYTECHNIC UNIVERSITY, Wuhu (CN)

(21) Appl. No.: 16/960,889

(22) PCT Filed: Jan. 10, 2019
(86) PCT No.: PCT/CN2019/071083

§ 371 Date: Jul. 9, 2020

(30) Foreign Application Priority Data
Jan. 10, 2018 (CN) 201810022132.2

(51) Int. Cl. A61H 3/00; A61H 3/02; B25J 9/00; B25J 13/08; B25J 9/14; B25J 9/16

(52) U.S. Cl. CPC A61H 3/00; A61H 2201/1676; B25J 9/0006; B25J 13/085; B25J 13/088; B25J 9/14; B25J 9/1651; A61H 2201/1659; A61H 2201/1207; A61H 2201/1246; A61H 2230/605; A61H 2201/5084; A61H 2201/5025; A61H 2201/5071; A61H 2201/1628; A61H 2201/5097; A61H 2205/088; A61H 2205/108; A61H 2205/106; A61H 2205/102; A61H 2003/007; A61H 2201/165; A61H 2201/5064; A61H 2201/5069; A61H 2201/5079; A61H 3/02

(57) ABSTRACT

A power-assist lower limb exoskeleton robot with adjustable stiffness joints includes a human-robot information interaction unit, an electronic control unit, an electro-hydraulic servo driving unit and a mechanical structure unit of a lower limb exoskeleton. In the mechanical structure unit of the lower limb exoskeleton, a hip joint and a hip joint connector are connected by a cross hinge mechanism. In combination with a bidirectional hydraulic cylinder, the hip joint of the lower limb exoskeleton fits well with the space structure characteristics of a human hip joint. The unidirectional hydraulic cylinders with spring reduction meets the needs of fast response and large torque during walking and increases walking endurance time. The present invention uses a plantar pressure information collection unit and a waist gyroscope to collect the human gait and gesture information. Besides, it uses a crutch unit to introduce wearer's movement intention into the exoskeleton robot's cooperative control.

### CROSS REFERENCE TO THE RELATED APPLICATIONS

This application is the national phase entry of International Application No. PCT/CN2019/071083, filed on Jan. 10, 2019, which is based upon and claims priority to Chinese Patent Application No. 201810022132.2, filed on Jan. 10, 2018, the entire contents of which are incorporated herein by reference.

### TECHNICAL FIELD

The present invention relates to the robotics technology field, especially involving a power-assist lower limb exoskeleton robot with adjustable stiffness joints.

### BACKGROUND

Conventional modes of transportation in pathless areas such as mountain and jungle often fail to meet the transport demand. In addition, power assist walking for elderly and disabled people, as well as operation featured by high intensity and flexibility in dangerous filed (such as firefighting, rescue, etc.) also need a non-traditional working tool. As a new robot, the wearable lower limb exoskeleton robot breaks through traditional limitations of human-robot relationship, which introduces human decision and realizes cooperative effort and highly intelligent power assist walking and filed work. Furthermore, it can expand the function of human body and provide new operation method to fulfil human-robot collaborated task in particular circumstances. Now the wearable lower limb exoskeleton robot is studied deeply and in the stage of rapid development.

For the wearable lower limb exoskeleton robot, there remain some common problems. Firstly, the wearing comfort is not ideal and the joint driving force of exoskeleton is not highly consistent with the characteristics of human during walking. Secondly, lightweight and compact design are not good. Thirdly, the efficiency of human-robot interaction is low. Considering the existing technology, the wearable lower limb exoskeleton robot has certain limitation. Several patents about lower limb exoskeleton are listed as follows: Patent 1: A wearable lower limb assist robot, its folding method and a hand box for shipment, application number: 201310257360.5; Patent 2: Portable wearable lower limb rehabilitation and walking assistance exoskeleton robot, application number: 201210370541.4; Patent 3: A gait device with crutches, application number: 201480016611.3. The patents above are motor-driving and can't fully meet the demand of response speed and force during walking. The space structure characteristics of human hip joint are not fully considered in the design of exoskeleton joints in patents above and there are some differences. In addition, the stiffness change of drive joints during walking is not considered in patents above. The considerations include impact force during heel strike of walking, response speed during spring phase and energy recovery during swing phase, which affect the harmony of human-robot compatible cooperation and interaction control, thus reducing the comfort and security in use.

Based on this, the present invention is put forward.

### SUMMARY

The present invention provides a power-assist lower limb exoskeleton robot with adjustable stiffness joints to solve problems above.

The power-assist lower limb exoskeleton robot with adjustable stiffness joints includes human-robot information interaction unit, electronic control unit, electro-hydraulic servo driving unit and mechanical structure unit of lower limb exoskeleton.

The said mechanical structure unit of lower limb exoskeleton is attached externally to human lower extremity.

The said human-robot information interaction unit obtains gait, gesture and movement intention information and sends them to electronic control unit.

The said electronic control unit receives and recognizes the information from human-robot information interaction unit. And then it sends relative control command to electro-hydraulic servo driving unit.

The said electro-hydraulic servo driving unit receives control commands. According to the command, it controls the starting, stopping and power-assist walking for the mechanical structure unit of lower limb exoskeleton and adjusts gait when it is unstable during walking.

Further, the said human-robot information interaction unit includes plantar pressure information collection unit, crutch unit and waist gyroscope.

The said plantar pressure information collection unit and waist gyroscope are installed in the mechanical structure unit of lower limb exoskeleton.

The plantar pressure information collection unit collects plantar pressure and then detects human gait while the lower limb exoskeleton assists people in walking.

The said crutch unit supports wearer and collects wearer's movement intention, sending those information to waist gyroscope.

The said waist gyroscope collects wearer's gesture information. Also, it receives information from plantar pressure information collection unit and crutch unit. Then waist gyroscope sends those information to electronic control unit.

Further, the said crutch unit includes crutch, gyroscope and bottom pressure sensor. The gyroscope and bottom pressure sensor are installed on crutch.

Further, the waist gyroscope, plantar pressure information collection unit and crutch unit have the wireless communication.

Optionally, the said electronic control unit includes main control module, proportional valve module, proportional relief valve module, motor driving module and battery module.

the said main control module recognizes human gesture and gait information. Then it chooses a suitable algorithm to analyze the stability region of the gait and fall prevention strategies. The module controls proportional relief valve to set the hydraulic system pressure and motor drive module to set the hydraulic system flow. Simultaneously, it controls proportional valve module to set the velocity and acceleration of hydraulic cylinder.

The said battery module, which functions by controlling the charging and discharging of batteries, provides power for the main control module, proportional valve module, proportional relief valve module and motor driving module.

Optionally, the said mechanical structure unit of lower limb exoskeleton robot includes left leg module, right leg module, hip joint connector, belt and backpack.

The said left leg module and right leg module are the same in structure, both of which include sole, ankle joint connecting plate, shank link, knee joint connector, thigh link and hip joint.

The said ankle joint connecting plate is connected on the outside of the sole and at the bottom of the shank link.

The said knee joint connector is connected at the top of shank link and the bottom of thigh link. The said hip joint is connected at the top of thigh link.

The said left and right hip joints are connected at the both ends of hip joint connector.

The said belt is connected in the front of hip joint connector.

The said backpack is connected at the top of hip joint connector.

Further, the said plantar pressure information collection unit includes plantar pressure information collection circuit board installed on ankle joint connecting plate and four force sensors installed on sole. The said plantar pressure information collection circuit board and four force sensors are connected through wires.

Optionally, the said electro-hydraulic servo driving unit includes hydraulic module, hip joint drive module and knee joint drive module.

The said hydraulic module is installed in the backpack and connected with hip joint drive module and knee joint drive module through the tubing.

The said drive module on the hip joint includes two hydraulic cylinders on hip joint. The two said hydraulic cylinders on the hip joint are used to drive hip joints of the left leg module and right leg module separately and thus to drive the left and right thigh links.

The said drive module on the knee joint includes two unidirectional hydraulic cylinders with spring reduction. The two unidirectional hydraulic cylinders with spring reduction are used to drive shank links of the left leg module and right leg module separately.

Further, the said hydraulic cylinder on the hip joint is a bidirectional hydraulic cylinder.

Optionally, the said hip joint and hip joint connector are connected through cross hinge mechanism.

Optionally, the said ankle joint connecting plate and the bottom of shank link are connected through cross hinge mechanism.

Optionally, the waist gyroscope and the main control module are connected through wires.

The present invention has the beneficial effects as follows:

1. In the mechanical structure unit of low limb exoskeleton, the hip joint and hip joint connector are connected by a cross hinge mechanism. In combination with the bidirectional hydraulic cylinder, the hip joint of exoskeleton fits well with characteristics of human hip joint's space structure and improves the wearing comfort.

2. The unidirectional hydraulic cylinders with spring reduction for adjustable stiffness meets the demand of fast response and large torque during walking, while increasing walking endurance time.

3. The present invention uses plantar pressure information collection unit and waist gyroscope to collect human gait and gesture information. In addition, using the crutch unit, it introduces wearer's movement intention in a simple and effective way. Thus, the present invention improves the integration between human-robot compatible cooperation and interaction control.

4. The present invention fixes some problems in the existing lower limb exoskeleton robot, which include poor compatible cooperation of human-robot and interaction control, low comfort and security in use.

### BRIEF DESCRIPTION OF THE DRAWINGS

FIG. 1 is a block diagram showing the composition of power-assist lower limb exoskeleton robot with adjustable stiffness joints.

FIG. 2 is a stereoscopic diagram showing the crutch unit of power-assist lower limb exoskeleton robot with adjustable stiffness joints.

FIG. 3 is a stereoscopic diagram showing the mechanical structure unit of lower limb exoskeleton robot.

FIG. 4 is a stereoscopic diagram showing the plantar pressure information collection unit.

FIG. 5 is a stereoscopic diagram showing the mechanical structure unit of waist and hip joint of the lower limb exoskeleton robot.

FIG. 6 is a stereoscopic diagram showing the backpack of power-assist lower limb exoskeleton robot with adjustable stiffness joints.

FIG. 7 is a stereoscopic diagram showing the unidirectional hydraulic cylinders with spring reduction.

FIG. 8 is a stereoscopic diagram showing the initial state of unidirectional hydraulic cylinders with spring reduction.

Human-robot information interaction unit 100, Plantar pressure information collection unit 110, Crutch unit 120, Crutch 121, Gyroscope 122, Bottom pressure sensor 123, Electronic control unit 200, Electro-hydraulic servo driving unit 300, Hydraulic module 310, Hip joint drive module 320, Bidirectional hydraulic cylinder 321, Knee joint drive module 330, Mechanical structure unit of lower limb exoskeleton robot 400, Left leg module 1a, Right leg module 1b, Hip joint connector 1c, Backpack 1f, Sole 2a, Ankle joint connecting plate 2b, Shank link 2c, Knee joint connector 2d, Thigh link 2e, Hip joint 2f, Unidirectional hydraulic cylinders with spring reduction 3a, Plantar pressure information collection circuit board 4a, Force sensor 4c, Set screw 5a, Waist width adjustment plates 5b, Curved board 5c, Cross hinge 5d, Y-joint 5e, Fixing plate for hydraulic cylinder on the hip joint 5f, Hydraulic cylinder on the hip joint 5g, Displacement sensor of hydraulic cylinder on the hip joint 5h, Waist square tube 5i, Guide rail fixing plate 5j, Tubing 5k, Motor reducer 6a, Hydraulic tank 6b, Frame of backpack 6c, External mounting plate 6d, Proportional valve block 6e, Electro-magnetic valve 6f, Quick-change connector of tubing 6g, Control box 6h, Motor driving 6j, Motor 6k.

### DETAILED DESCRIPTION OF THE EMBODIMENTS

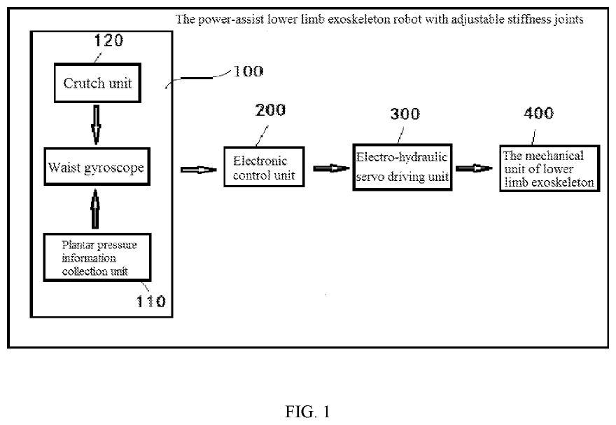

Below in combination with attached FIGS. 1-8, a further explanation is made for the present invention.

As shown in FIG. 1, the present invention of the power-assist lower limb exoskeleton robot includes: human-robot information interaction unit 100, electronic control unit 200, electro-hydraulic servo driving unit 300 and mechanical structure unit 400 of lower limb exoskeleton robot. Human-robot information interaction unit 100 is connected with electronic control unit 200. Electro-hydraulic servo driving unit 300 is connected with electronic control unit 200 and mechanical structure unit 400 of lower limb exoskeleton robot respectively. In which,

Mechanical structure unit 400 of the lower limb exoskeleton robot is attached externally to human lower extremity.

The electro-hydraulic servo driving unit 300 is used to control the starting, stopping and power-assist walking of the lower limb exoskeleton mechanical structure unit 400. In addition, it adjusts gaits while it is unstable during walking.

The human-robot information interaction unit 100 includes plantar pressure information collection unit 110, crutch unit 120 and waist gyroscope.

The plantar pressure information collection unit 110 and waist gyroscope are installed on the mechanical structure unit 400 of lower limb exoskeleton robot.

The plantar pressure information collection unit 110 collects plantar pressure and then recognizes gait while the robot assists human's lower limb in walking.

The crutch unit 120 supports wearer, collecting wearer's movement intention and then sending the information to waist gyroscope.

The waist gyroscope collects gesture information, receiving information from plantar pressure information collection unit 110 and crutch unit 120, and then sending the information to electronic control unit 200.

The electronic control unit 200 receives and recognizes information from waist gyroscope. Through processing, it sends out relative control signal to electro-hydraulic servo driving unit 300 to control the starting, stopping and walking speed for the mechanical structure unit 400 of lower limb exoskeleton robot.

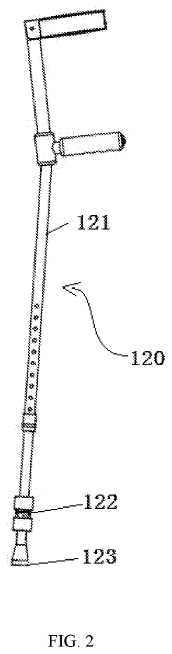

As shown in FIG. 2, the crutch unit 120 includes crutch 121, gyroscope 122 and pressure sensor 123. The gyroscope 122 and pressure sensor 123 are installed on crutch 121. Typically, the crutch unit 120 supports wearer's armpit during walking. The pressure sensor 123 measures the contact force between crutch unit 120 and ground. The gyroscope 122 measures the tilt angle of crutch unit 120. The measured information will be sent to the waist gyroscope to recognize the movement intention of wearers.

Further, the waist gyroscope and plantar pressure information collection unit 110 and crutch unit 120 have the wireless communication.

In one embodiment, the human-robot information interaction unit 100 also includes joint displacement measurement unit, motor speed measurement unit and oil pressure measurement unit of inlet and outlet of the hydraulic cylinder.

In one embodiment, the electronic control unit 200 includes main control module, proportional valve module, proportional relief valve module, motor driving module and battery module.

The said main control module recognizes human gesture and gait information. Then it chooses a suitable algorithm to analyze the stability region of the gait and fall prevention strategies. The main control module controls proportional relief valve to set the hydraulic system pressure, while controlling motor driving module to set the hydraulic system flow and proportional valve module to set the velocity and acceleration of hydraulic cylinder.

The said battery module, which functions by controlling the charging and discharging of batteries, provides power for the main control module, proportional valve module, proportional relief valve module and motor driving module.

The electronic control unit 200 is installed in the backpack.

In one embodiment, the means of communication between the waist gyroscope and exoskeleton main control module can be wired or wireless.

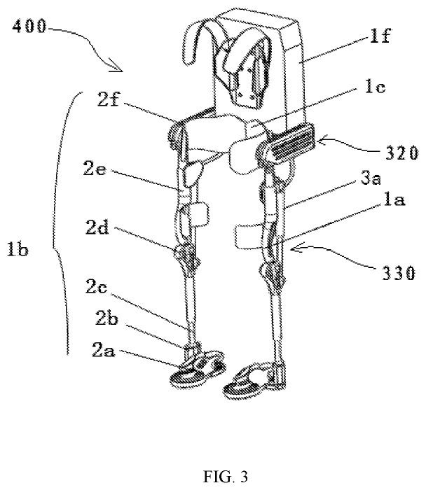

In one embodiment, the mechanical structure of power-assist lower limb exoskeleton robot with adjustable stiffness joints is shown in FIG. 3. The mechanical structure unit 400 of lower limb exoskeleton robot includes left leg module 1a, right leg module 1b, hip joint connector 1c, belt and backpack 1f. Left leg module 1a and right leg module 1b are the same in structure, both of which include sole 2a, ankle joint connecting plate 2b, shank link 2c, knee joint connector 2d, thigh link 2e and hip joint 2f. The ankle joint connecting plate 2b is connected on the outside of sole 2a and at the bottom of shank link 2c. The knee joint connector 2d is connected at the top of shank link 2c and the bottom of thigh link 2e. The hip joint is connected at the top of thigh link 2e. The hip joints of left leg module 1a and right leg module 1b are connected at the both ends of hip joint connector 1c. The belt is connected in the front of hip joint connector 1c. The backpack is connected at the top of hip joint connector 1c. The weight of whole lower limb exoskeleton robot is transmitted to the bearing surface of sole 2a through the mechanical structure unit 400 of lower limb exoskeleton robot, thus reducing the weight on wearers. The electronic control unit 200 and electro-hydraulic servo driving unit 300 are installed in backpack 1f, which optimizes the integration of power-assist lower limb exoskeleton robot.

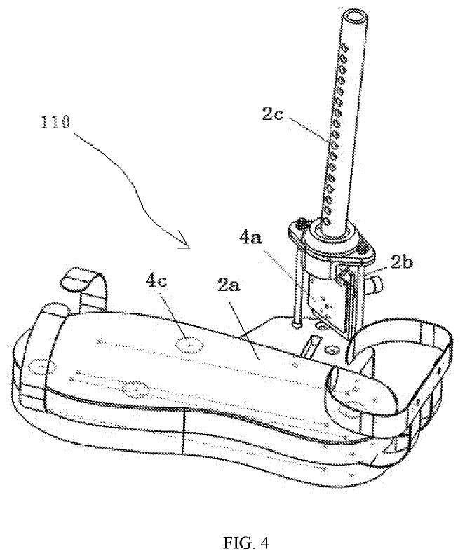

The schematic diagram of the plantar pressure information collection unit 110 of the present invention is shown in FIG. 4. Unit 110 includes plantar pressure information collection circuit board 4a installed on ankle joint connecting plate and four force sensors installed on sole 2a. The plantar pressure information collection circuit board 4a and four force sensors are connected through wires. The plantar pressure information collection unit 110 is used to collect the information of plantar pressure. In Combination with the information collected from waist gyroscope, unit 4a calculates the gait, posture and stability of wearer synthetically. At the same time, it introduces wearer's movement intention into the cooperative control of the lower limb exoskeleton robot through crutch unit 120 in a simple and effective way. Thus, the compatible cooperation of human-robot interaction control is improved. The waist gyroscope, plantar pressure information collection unit 110, joint displacement measurement unit, pressure measurement unit for hydraulic cylinder, hydraulic module 310 and measurement unit for motor speed are all connected with electronic control unit 200 by the wireless communication and optimize the human-robot interaction channels.

In one embodiment, the electro-hydraulic servo driving unit 300 includes hydraulic module 310, hip joint drive module 320 and knee joint drive module 330. The hydraulic module 310 is installed in backpack 1f and connected with hip joint drive module 320 and knee joint drive module 330 through the tubing.

As shown in FIGS. 3, 5 and 6, the hydraulic module 310 includes hydraulic tank 6b, proportional valve 6e, electro-magnetic valve 6f and tubing quick-change connector 6g. The pressurized oil in hydraulic tank 6b is transmitted to hip joint drive module 320 and knee joint drive module 330 through proportional valve 6e, electro-magnetic valve 6f, tubing quick-change connector 6g and tubing, to drive hip joint 2f, left leg module 1a and right leg module 1b.

The hip joint drive module 320 includes two hydraulic cylinders 5g on the hip joint. The hydraulic cylinder 5g on the hip joint is bidirectional hydraulic cylinder 321. Two bidirectional hydraulic cylinders 321 are used to drive hip joint 2f of the left leg module 1a and right leg module 1b, thus driving thigh link 2e.

The knee joint drive module 330 includes two unidirectional hydraulic cylinders with spring reduction 3a. The two unidirectional hydraulic cylinders with spring reduction 3a are used to drive shank link 2c of the left leg module 1a and right leg module 1b.

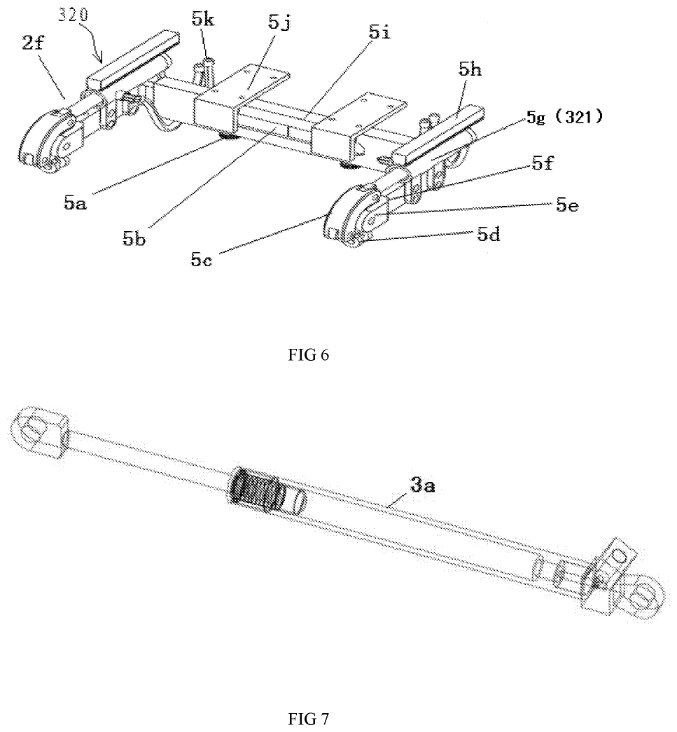

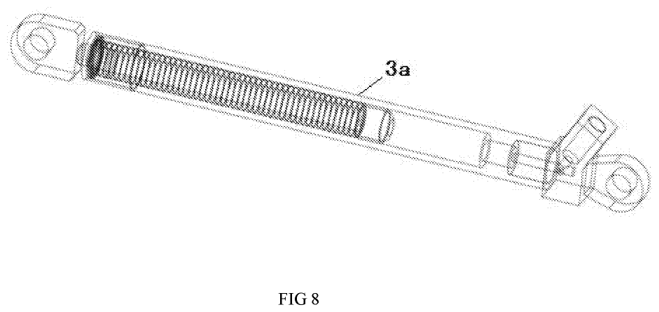

The unidirectional hydraulic cylinders with spring reduction 3a, featured by energy storage and power assistance, is also characterized in its high consistence with the energy output characteristics of human's joints during walking. The cylinders 3a can be power assisted with adjustable stiffness and reduce impact. Enhancing walking flexibility, it can also recover the feedback energy of knee joint. As shown in FIGS. 7 and 8, the stiffness of hydraulic cylinder 3a and preload force of the spring can be set. The setting can improve the response speed of hydraulic cylinder and meet the needs of fast response, large torque when wearers walk. The max impact between wearer and ground during heel strike of walking is the equivalent of four times as the body weight. With the use of design above, the lower limb exoskeleton robot can recycle energy in the swing phase of walking. Consequently, it improves energy utilization efficiency and increases robot endurance time. At the same time, 3a alleviates impact and enhances flexibility during walking.

In one preferred embodiment, the hip joint 2f and hip joint connector 1c are connected through cross hinge mechanism. Including cross hinge 5d, the cross hinge mechanism simulates two degrees of freedom of hip joint and limits its motion range. In combination with the hydraulic cylinder hip joint, the hinge can simulate the movement of human hip joint well.

In another preferred embodiment, the ankle joint connecting plate 2b and shank link 2c are connected through cross hinge mechanism including cross hinge. The cross hinge mechanism simulates two degrees of freedom of ankle joint and limits its motion range.

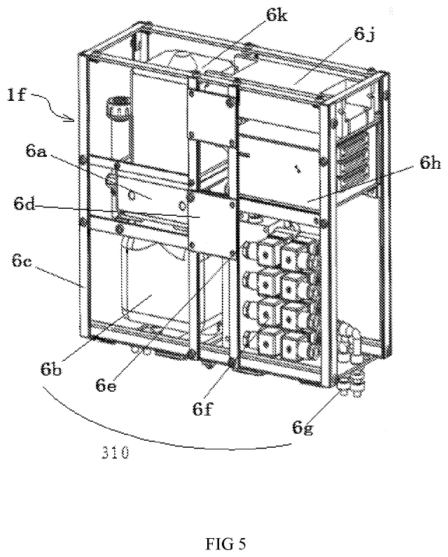

FIG. 5 shows schematic diagram for the waist and hip joint 2f on the mechanical structure unit 400 of lower limb exoskeleton robot. The waist is composed of set screw 5a, waist width adjustment plates 5b, curved board 5c, cross hinge 5d, Y-joint 5e, fixing plate for hip joint hydraulic cylinder 5f, hydraulic cylinder 5g on the hip joint, displacement sensor of hydraulic cylinder 5h on the hip joint, waist square tube 5i, guide rail fixing plate 5j and tubing 5k in turn. The set screw 5a is used to fix guide rail fixing plate 5j on waist square tube 5i. The waist width adjustment plates 5b is used to adjust waist width. The curved board 5c and cross hinge 5d are used to transmit force from hydraulic cylinder 5g to hip joint 2f. Y-joint 5e is used to support cross hinge 5d. The fixing plate for hydraulic cylinder 5f on the hip joint is used to fix Y-joint 5e, hydraulic cylinder 5g on the hip joint and waist square tube 5i. The displacement sensor 5h of is fixed on the hydraulic cylinder 5g to measure the displacement of hydraulic rod on the hip joint. The guide rail fixing plate 5j is used to fixed guide rail. The tubing 5k is used to connect drive module of hip joint. The hydraulic cylinder 5g on the hip joint adopts bidirectional hydraulic cylinder 321.

In one embodiment, the waist gyroscope is fixed on belt.

The workflow of the present invention—a power-assist lower limb exoskeleton robot with adjustable stiffness joints is as below:

S101, the crutch unit 120 captures the wearer's movement intention;

S102, the plantar pressure information collection unit 110 of human-robot information interaction unit 100 gathers plantar pressure during walking and then recognizes human gait;

S103, the waist gyroscope of human-robot information interaction unit 100 gathers human gesture and receives the information from plantar pressure information collection unit 110 and crutch unit 120.

S104, the electronic control unit 200 receives and recognizes information from the waist gyroscope. According to those information, it sends relative control signal to electro-hydraulic servo driving unit 300.

S105, according to the received information, the electro-hydraulic servo driving unit 300 controls the starting, stopping and walking speed for mechanical structure unit 400 of lower limb exoskeleton robot.

The specific implementation ways above elaborates on the purpose, technical scheme and beneficial effects of the present invention. The above is only a specific implementation way of the present invention and not used to limit the scope of invention protection. Any modifications, equivalent replacement, improvement, etc. of the present invention specific implementation way shall be included in the protection scope of the present invention.

What is claimed is:

1. A power-assist lower limb exoskeleton robot with adjustable stiffness joints, comprising a human-robot information interaction unit, an electronic control unit, an electro-hydraulic servo driving unit and a mechanical structure unit of a lower limb exoskeleton, wherein
the mechanical structure units of the lower limb exoskeleton are attached externally to a lower limb of a wearer;
the human-robot information interaction unit obtains information of a human gait, a gesture and a movement intention of the wearer, and sends the information of the human gait, the gesture and the movement intention of the wearer to the electronic control unit;
the electronic control unit receives and recognizes the information from the human-robot interaction unit, the electronic control unit sends out a relative control signal to the electro-hydraulic servo driving unit; and
the electro-hydraulic servo driving unit receives the relative control signal to control the starting, stopping, power assist walking of the mechanical structure unit of the lower limb exoskeleton to start, stop, walk in a power-assist manner and adjusts the human gait when the mechanical structure unit of the lower limb exoskeleton is unstable during walking.

2. The power-assist lower limb exoskeleton robot according to claim 1, wherein, the human-robot information interaction unit comprises a plantar pressure information collection unit, a crutch unit and a waist gyroscope;
the plantar pressure information collection unit and the waist gyroscope are installed in the mechanical structure unit of the lower limb exoskeleton;
the plantar pressure information collection unit collects plantar pressure and then recognizes the human gait when the lower limb exoskeleton assists people the wearer in walking;
the crutch unit supports the wearer, collects the movement intention of the wearer and sends the information of the movement intention to the waist gyroscope; and
the waist gyroscope collects the information of the gesture of the wearer and receives the information from the plantar pressure information collection unit and crutch unit, and sends the information of the human gait, the movement intention and the gesture to the electronic control unit.

3. The power-assist lower limb exoskeleton robot according to claim 2, wherein, the crutch unit comprises a crutch, a gyroscope and a bottom-loading pressure sensor, the gyroscope and the bottom-loading pressure sensors are installed in the crutch.

4. The power-assist lower limb exoskeleton robot according to claim 2, wherein, the waist gyroscope, the plantar pressure information collection unit and the crutch unit communicate in a wireless manner.

5. The power-assist lower limb exoskeleton robot according to claim 1, wherein, the electronic control unit comprises a main control module, a proportional valve module, a proportional relief valve module, a motor driving module and a battery module;
after the main control module recognizes the information of the gesture and the human gait of the wearer, an algorithm is configured to analyze the stability region and fall prevention strategies, based on the algorithm, the main control module controls the proportional relief valve module to set power of a hydraulic cylinder, and controls the motor driving module to set the hydraulic system flow, and controls proportional valve module to set a velocity and an acceleration of the hydraulic cylinder; and
the battery module is configured to control batteries to charge and discharge, and is connected to the main control module, the proportional valve module, the proportional relief valve module and the motor driving module.

6. The power-assist lower limb exoskeleton robot according to claim 1, wherein, the mechanical structure unit of the lower limb exoskeleton comprises a left leg module, a right leg module, a hip joint connector, a belt and a backpack;
the left leg module and the right leg module are structurally identical, each of the left leg module and the right leg module comprises a sole, an ankle joint connecting plate, a shank link, a knee joint connector a thigh link and a hip joint;
the ankle joint connecting plate is connected to an outside of the sole and a bottom of the shank link;
the knee joint connector is connected to a top of the shank link and a bottom of the thigh link, the hip joint is connected to a top of the thigh link;
the hip joints of the left leg module and the right leg module are connected to both ends of the hip joint connector;
the belt is connected to a front of the hip joint connector; and
the backpack is connected to a top of the hip joint connector.

7. The power-assist lower limb exoskeleton robot according to claim 6, wherein, the plantar pressure information collection unit comprises a plantar pressure information collection circuit board installed on the ankle joint connecting plate and four force sensors installed on the sole, the plantar pressure information collection circuit board-era) and the four force sensors are connected through wires.

8. The power-assist lower limb exoskeleton robot according to claim 6, wherein, the electro-hydraulic servo driving unit comprises a hydraulic module, a hip joint drive module and a knee joint drive module;
the hydraulic module is installed in the backpack and connected to the hip joint drive module and the knee joint drive module through a tubing;
the hip joint drive module comprises two hydraulic cylinders on the hip joint, the two hydraulic cylinders on the hip joint are configured to drive the hip joints of the left leg module and the right leg module separately, and the hip joints are configured to drive the thigh links of the left leg module and the right leg module; and
the knee joint drive module comprises two unidirectional hydraulic cylinders with spring reduction, the two unidirectional hydraulic cylinders with the spring reduction are configured to drive the shank links of the left leg module and the right leg module separately.

9. The power-assist lower limb exoskeleton robot according to claim 6, wherein, the ship joint and the hip joint connector are connected through a cross hinge mechanism.

10. The power-assist lower limb exoskeleton robot according to claim 6, wherein, the ankle joint connecting plate and the shank link are connected through a cross hinge mechanism.

11. The power-assist lower limb exoskeleton robot according to claim 2, wherein, the mechanical structure unit of the lower limb exoskeleton comprises a left leg module, a right leg module, a hip joint connector, a belt and a backpack;
the left leg module and the right leg module are structurally identical, each of the left leg module and the right leg module comprises a sole, an ankle joint connecting plate, a shank link, a knee joint connector, a thigh link and a hip joint;
the ankle joint connecting plate is connected to an outside of the sole and a bottom of the shank link;
the knee joint connector is connected to a top of the shank link and a bottom of the thigh link, the hip joint is connected to a top of the thigh link;
the hip joints of the left leg module and the right leg module are connected to both ends of the hip joint connector;
the belt is connected to a front of the hip joint connector; and
the backpack is connected to a top of the hip joint connector.

12. The power-assist lower limb exoskeleton robot according to claim 3, wherein, the mechanical structure unit of the lower limb exoskeleton comprises a left leg module, a right leg module, a hip joint connector, a belt and a backpack;
the left leg module and the right leg module are structurally identical, each of the left leg module and the right leg module comprises a sole, an ankle joint connecting plate, a shank link, a knee joint connector, a thigh link and a hip joint;
the ankle joint connecting plate is connected to an outside of the sole and a bottom of the shank link;
the knee joint connector is connected to a top of the shank link and a bottom of the thigh link, the hip joint is connected to a top of the thigh link;
the hip joints of the left leg module and the right leg module are connected to both ends of the hip joint connector;
the belt is connected to a front of the hip joint connector; and
the backpack is connected to a top of the hip joint connector.

13. The power-assist lower limb exoskeleton robot according to claim 4, wherein, the mechanical structure unit of the lower limb exoskeleton comprises a left leg module, a right leg module, a hip joint connector, a belt and a backpack;
the left leg module and the right leg module are structurally identical, each of the left leg module and the right leg module comprises a sole, an ankle joint connecting plate, a shank link, a knee joint connector, a thigh link and a hip joint;
the ankle joint connecting plate is connected to an outside of the sole and a bottom of the shank link;
the knee joint connector is connected to a top of the shank link and a bottom of the thigh link, the hip joint is connected to a top of the thigh link;
the hip joints of the left leg module and the right leg module are connected to both ends of the hip joint connector;
the belt is connected to a front of the hip joint connector; and
the backpack is connected to a top of the hip joint connector.

14. The power-assist lower limb exoskeleton robot according to claim 5, wherein, the mechanical structure unit of the lower limb exoskeleton comprises a left leg module, a right leg module, a hip joint connector, a belt and a backpack;
the left leg module and the right leg module are structurally identical, each of the left leg module and the right leg module comprises a sole, an ankle joint connecting plate, a shank link, a knee joint connector, a thigh link and a hip joint;
the ankle joint connecting plate is connected to an outside of the sole and a bottom of the shank link;
the knee joint connector is connected to a top of the shank link and a bottom of the thigh link, the hip joint is connected to a top of the thigh link;
the hip joints of the left leg module and the right leg module are connected to both ends of the hip joint connector;
the belt is connected to a front of the hip joint connector; and
the backpack is connected to a top of the hip joint connector.
